(19) United States
(12) Patent Application Publication
(10) Pub. No.: US 2026/0165903 A1
(43) Pub. Date: Jun. 18, 2026

(54) TEMPOROMANDIBULAR JOINT (TMJ) TOOL AND ASSOCIATED METHODS FOR TREATING TMJ DISORDERS

(71) Applicant: LIL SHEPHERD BOY, LLC, Orlando, FL (US)

(72) Inventor: Mary RAVNDAL, Orlando, FL (US)

(21) Appl. No.: 18/983,840

(22) Filed: Dec. 17, 2024

(51) Int. Cl. A61H 7/00; A61H 23/02

(52) U.S. Cl. CPC A61H 7/003; A61H 23/0254; A61H 2201/0153; A61H 2201/0207; A61H 2201/0228; A61H 2201/1692; A61H 2205/026

(57) ABSTRACT

A temporomandibular joint (TMJ) tool for treating TMJ disorders includes a core gripping section to be carried in a palm of a user's hand. A pair of upper tongs extends outwards from an upper end of the core gripping section, with each upper tong having a free end that is movable. A lower tong extends outwards from a lower end of the core gripping section, with the lower tong having a free end that is movable. A pair of upper pads is carried by the free ends of the pair of upper tongs, and a lower pad is carried by the free end of the lower tong. The upper and lower pads are configured to simulate fingertips on the user's hand when the TMJ tool is treating the TMJ disorders.

### TECHNICAL FIELD

The present disclosure relates to tools for providing relief of mouth and jaw discomfort, and, more particularly, to a tool for treating temporomandibular joint (TMJ) disorders, and associated methods.

### BACKGROUND

In anatomy, temporomandibular joints (TMJ) are the two joints connecting the jawbone to the skull. In particular, the TMJ is between the mandible and the temporal bone of the skull. These joints are unique in their bilateral function with respect to being connected via the mandible.

TMJ disorders are conditions that cause pain and dysfunction in the jaw joints and muscles that control jaw movement. TMJ disorders can result in significant pain and impairment in the lower jaw and in the muscles that control jaw movement.

U.S. publication no. US2005/0039760 discloses a tool for intra oral myofascial trigger point therapy for TMJ disorder. The tool is a handheld device for insertion into the mouth for applying pressure to a trigger point near the TMJ. The device includes a central gripping portion having a pair of opposed ends and a plurality of gripping faces extending between the opposed ends. A first generally arcuate arm extends from one of the opposed ends, and a second generally arcuate arm extends from the other end of the central gripping portion. After one of the tips of the first or second generally arcuate arm is inserted into the subject's mouth and is brought into contact with one of the treatment points, pressure is applied to the treatment point until a release response occurs.

International publication no. WO2009/150685 discloses a tool for mechanical stimulation for improving articular function of temporomandibular joints. The tool includes stabilization mechanical means connected to support mechanical means, and vibrating means that produce mechanical vibration of the support mechanical means. The support mechanical means come in contact with a mouth of a patient to transmit the mechanical vibration to at least one temporomandibular joint of the patient. The stabilization mechanical means stabilizes the contact between the support mechanical means and the patient.

Even in view of the above tools for treating TMJ disorder, there is still a need to improve on treatment of TMJ disorders.

### SUMMARY

A temporomandibular joint (TMJ) tool for treating TMJ disorders includes a core gripping section configured to be carried in a palm of a user's hand. A pair of upper tongs may extend outwards from an upper end of the core gripping section, with each upper tong having a free end that is movable. A lower tong may extend outwards from a lower end of the core gripping section, with the lower tong having a free end that is movable. A pair of upper pads is carried by the free ends of the pair of upper tongs, and a lower pad is carried by the free end of the lower tong. The upper and lower pads may be configured to simulate fingertips on the user's hand when the TMJ tool is treating the TMJ disorders.

The core gripping section may have an arcuate shape, the pair of upper tongs may have an arcuate shape, and the lower tong may have an arcuate shape. Based on the respective arcuate shapes, the pair of upper pads are facing the lower pad.

The upper and lower tongs each comprise a finger loop holder configured to hold in place fingers on the user's hand when the TMJ tool is treating the TMJ disorders. Each finger loop holder may be formed out of silicon.

A medial section of the upper end of the core gripping section includes an opening that separates the pair of upper tongs. The opening is circular-shaped to allow at least one of lateral movement and circular movement of the pair of upper tongs.

The upper and lower pads may each be formed out of silicon. The core gripping section, the pair of upper tongs and the lower tong may be formed out of a flexible material so that the TMJ tool is pliable. The flexible material may be a thermoplastic.

The core gripping section, the pair of upper tongs and the lower tong may each include a textured gripping surface. The textured gripping surface may be inlaid or wraps around the core gripping section and the upper and lower tongs.

The upper and lower tongs may each include a respective vibration module configured to vibrate the respective upper and lower tongs when the TMJ tool is treating the TMJ disorders.

The free ends of the upper and lower tongs may each include a respective heating element configured to heat the respective upper and lower pads when the TMJ tool is treating the TMJ disorders.

Another aspect is directed to a method for temporomandibular joint (TMJ) disorders. The method includes providing a TMJ tool as described above. The upper and lower pads may be positioned to contact soft tissue and muscles of the user's mouth and jaw area, Pressure may be applied to the TMJ tool by the user so that the upper and lower pads simulate fingertips on the user's hand to treat the TMJ disorders.

The pressure may be applied to the soft tissue and muscles outside of the user's mouth and jaw area. The upper pads may be positioned above the jaw area and the lower pad is positioned under a chin area of the user.

The pressure may be applied to the soft tissue and muscles inside of the user's mouth and jaw area. One or both of the upper pads may be placed inside the user's mouth while the lower pad is placed outside the user's mouth. Alternatively, the lower pad may be placed inside the user's mouth while the upper pads are placed outside the user's mouth.

### BRIEF DESCRIPTION OF THE DRAWINGS

FIG. 1 is an upper perspective view of a temporomandibular joint (TMJ) tool for treating TMJ disorder in which various aspects of the disclosure may be implemented.

FIG. 2 is a bottom perspective view of the TMJ tool illustrated in FIG. 1.

FIG. 3 is a front view of the TMJ tool illustrated in FIG. 1.

FIG. 4 is a back view of the TMJ tool illustrated in FIG. 1.

FIG. 5 is a top view of the TMJ tool illustrated in FIG. 1.

FIG. 6 is a bottom view of the TMJ tool illustrated in FIG. 1.

FIG. 7 is a side view of the TMJ tool illustrated in FIG. 1.

FIG. 8 is an upper perspective view of the TMJ tool illustrated in FIG. 1 with heating elements and vibration modules in the upper and lower tongs.

FIG. 9 is an upper perspective view of the TMJ tool illustrated in FIG. 1 with textured gripping surfaces.

FIG. 10 is a back view of the TMJ tool illustrated in FIG. 9.

FIG. 11 is a top view of the TMJ tool illustrated in FIG. 0.

FIG. 12 is a flowchart for using the TMJ tool illustrated in FIG. 1 to treat TMJ disorders.

FIG. 13 is an image of a user gripping the TMJ tool illustrated in FIG. 1 and applying pressure to the soft tissue and muscles outside the user's mouth.

FIG. 14 is an image of the user illustrated in FIG. 13 applying pressure with the TMJ tool to the soft tissue and muscles inside the mouth.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

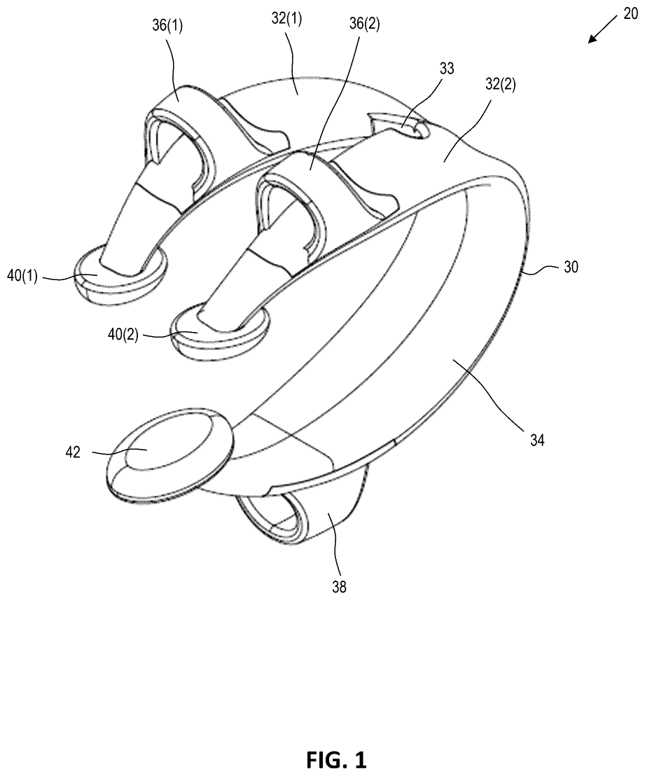

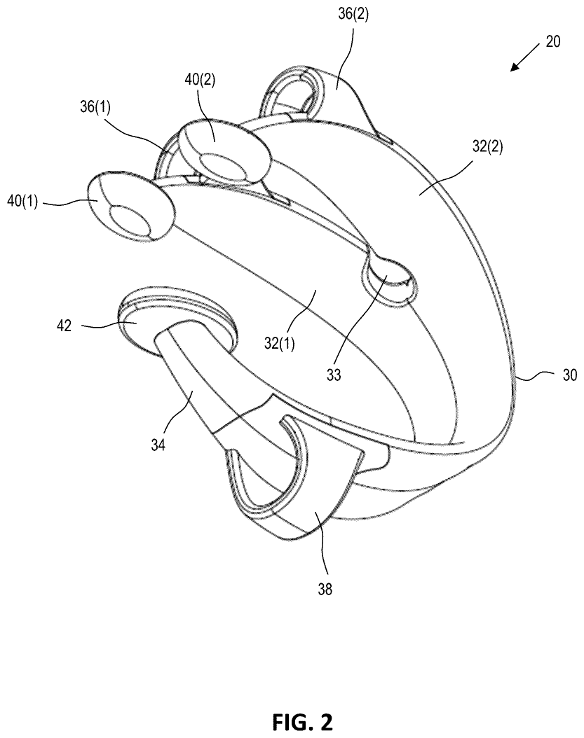

Referring initially to FIGS. 1 and 2, a temporomandibular joint (TMJ) tool 20 for treating TMJ disorders will be discussed. Temporomandibular joints connect the jawbone to the skull, and the TMJ tool 20 is intended to loosen or unstick soft tissue and muscles engaging the temporomandibular joints when a user is experiencing TMJ disorders.

The TMJ tool 20 is intended to target and treat soft tissue and muscles outside the mouth, above and below the mandible and inside the mouth. This includes the masseter muscle, medial pterygoid, lateral pterygoid, surrounding soft tissue, muscles bellies and attachments that contribute to jaw pain in the upper neck and head. The TMJ tool 20 is designed to mimic therapeutic palpations applied during office treatments, and to keep muscles targeting the TMJ and soft tissue from reverting back to hypertonicity and patterns that facilitate pain.

The TMJ tool 20 is pliable and includes a core gripping section 30 configured to be carried in a palm of a user's hand. A pair of upper tongs 32(1), 32(2) extend outwards from an upper end of the core gripping section 30. The upper tongs 32(1), 32(2) may be generally referred to as upper tongs 32. Each upper tong 32 has a free end that is movable based on pressure applied by the user's hand.

A lower tong 34 extends outwards from a lower end of the core gripping section 30. The lower tong 34 has a free end that is also movable based on pressure applied by the user's hand.

A pair of upper pads 40(1), 40(2) is carried by the free ends of the pair of upper tongs 32(1), 32(2), and a lower pad 42 is carried by the free end of the lower tong 34. The upper pads 40(1), 40(2) may be generally referred to as upper pads 40. The upper and lower pads 40, 42 are generally soft and flexible, and are configured to simulate fingertips on the user's hand when the TMJ tool 20 is treating the TMJ disorders. The upper and lower pads 40, 42 may be silicon, for example.

The user holds the TMJ tool 20 similar to holding or gripping a baseball. When the user's palm is placed over the core gripping section 30, the user's thumb is positioned on the lower tong 34, and two fingers on the same hand are positioned on the upper tongs 32. The two fingers may be the ring finger, the middle finger and/or the index finger. In response to pressure being applied by the user's hand, the free ends of the upper and lower tongs 32, 34 may be moved towards one another. This allows pressure to be applied to the TMJ joint area via the upper and lower pads 40, 42.

The TMJ tool 20 includes finger loop holders to hold in place fingers on the user's hand when the TMJ tool 20 is engaging the TMJ joint area. The upper tongs 32(1), 32(2) includes upper finger loop holders 36(1), 36(2) for two of the user's two fingers. The upper finger loop holders 36(1), 36(2) may be generally referred to as upper finger loop holders 36. Likewise, the lower tong 34 includes a lower finger loop holder 38 for the user's thumb. The upper and lower finger loop holders 36, 38 advantageously prevent the user's fingers and thumb from slipping off of anyone of the upper and lower tongs 34, 36 when pressure is applied to the TMJ tool 20.

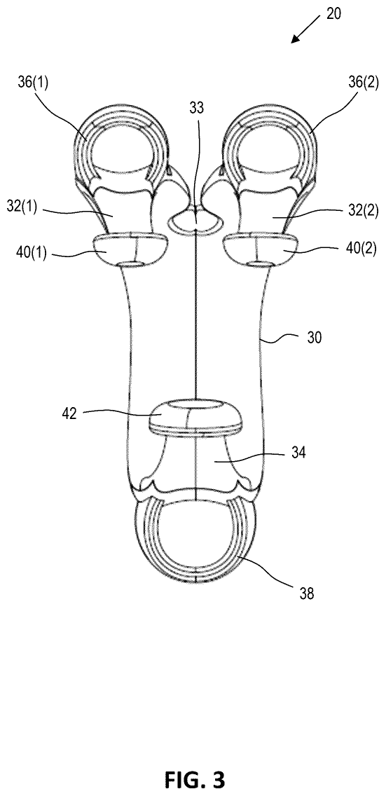

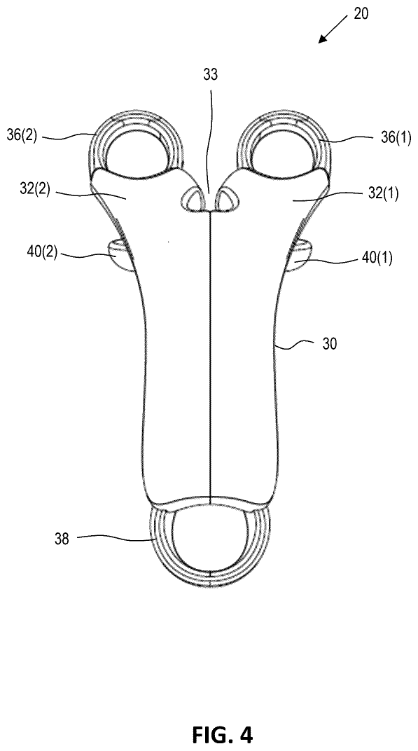

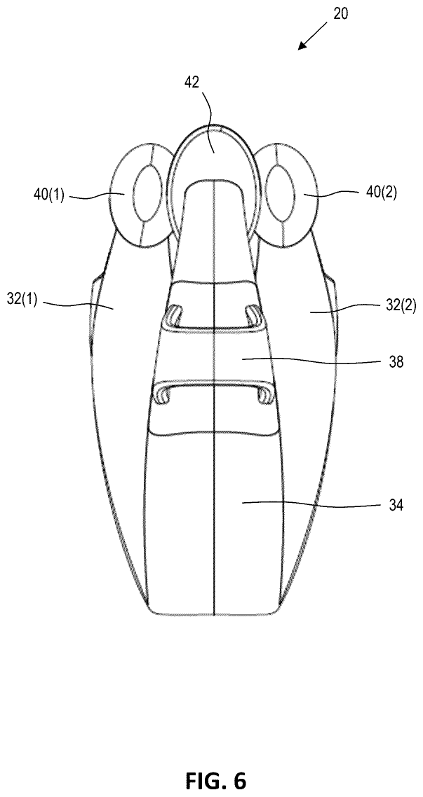

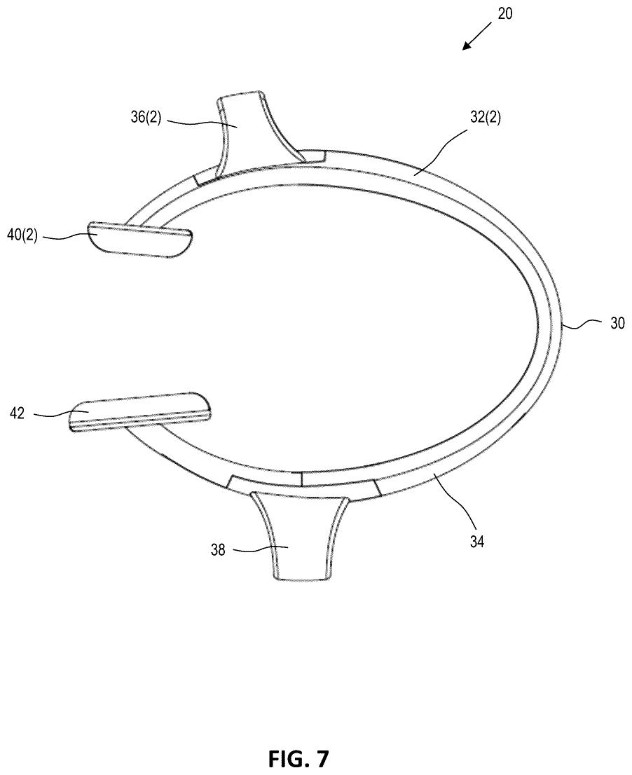

Additional views of the TMJ tool 20 are provided in FIGS. 3-7. The core gripping section 30 has an arcate shape, the pair of upper tongs 32 have an arcuate shape, and the lower tong 34 has an arcuate shape, as illustrated by a right side view of the TMJ tool 20 in FIG. 7. Based on the curvature of the respective arcuate shapes, the pair of upper pads 40 are facing the lower pad 42.

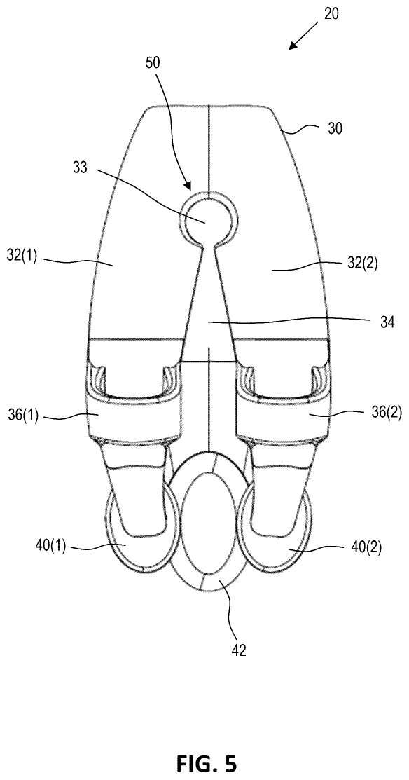

Referring now to the top view of the TMJ tool 20 as illustrated in FIG. 5, a medial section 50 of the upper end of the core gripping section 30 includes an opening 33 that separates the pair of upper tongs 32(1), 32(2). The opening 33 is circular-shaped to allow lateral and circular movement of the pair of upper tongs 32(1), 32(2) based on pressure applied by the user's hand. The opening 33 is not to be limited to a circular-shape, as other shapes may be used to provide sufficient separation between the pair of upper tongs 32(1), 32(2), such as a diamond-shape.

The upper tongs 32 are equally sized. At the upper end of the core gripping section 30, a width of each tong 32 tapers to the free end holding the upper pad 40. The lower tong 34 is larger in size as compared to each of the upper tongs 32.

At the lower end of the core gripping section 30, a width of the lower tong 34 tapers to the free end holding the lower pad 42. Since the lower tong 34 is larger in size, the lower pad 42 is also larger in size as compared to a size of the upper pads 40. As illustrated in FIG. 5, a width of the lower pad 42 overlaps a portion of each upper pad 40, and a length of the lower pad 42 extends beyond a length of each upper pad 40.

As noted above, the TMJ tool 20 is pliable. The TMJ tool 20 may be formed using thermoplastic materials. A thermoplastic is a plastic material that becomes pliable and moldable when heated above a specific temperature, and solidifies when cooled. Example thermoplastic materials include polypropylene, polycarbonate, polystyrene and polyethylene, for example.

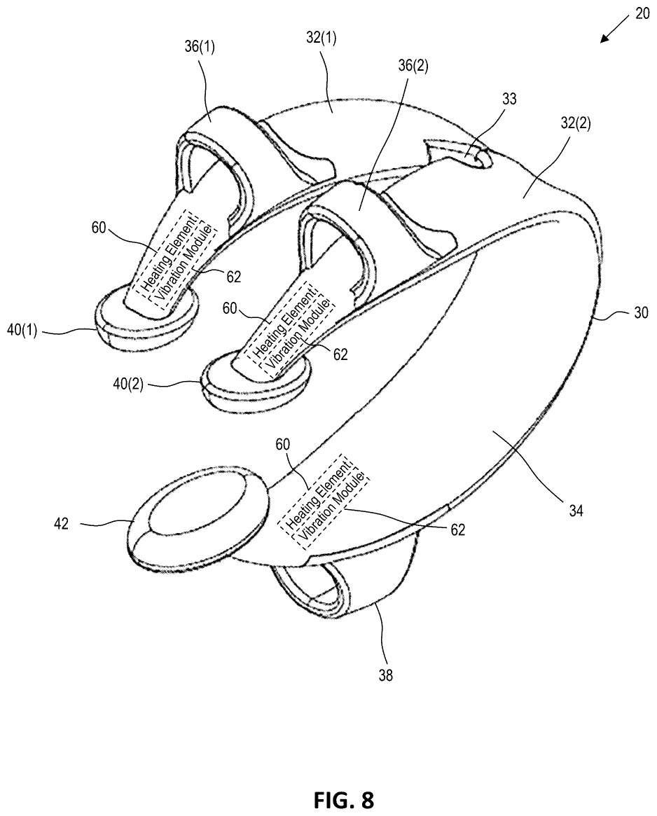

Referring now to FIG. 8, the TMJ tool 20 may be configured to include heating elements 60 in each of the upper and lower tongs 32, 34 in order to heat the upper and lower pads 40, 42. Each heating element 60 is embedded within the upper or lower tongs 32, 34. The heat generated by the heating elements 60 enhances muscle relaxation and boosts blood circulation, providing additional relief for discomfort areas.

Each heating element 60 may be configured as a thin, wire-like component, usually made from a high-resistance alloy like nichrome, which generates heat when an electric current passes through it. As electric current passes through the heating element 60 the free ends of the upper and lower tongs 32, 34 are heated.

The heating elements 60 are battery operated. Each heating element 60 may have its own battery co-located at the heating element. In other embodiments, the TMJ tool 20 includes a shared battery to power all three of the heating elements 60. The individual batteries or the shared battery may be rechargeable by connecting a cable of a charger to a charging port within the TMJ tool 20.

Each heating element 60 may have its own on/off switch for individual control. In other embodiments, a single on/off switch may be used to operate the heating elements 60 so that they all heat at the same time.

Each heating element 60 may be configured to operate at a set temperature. In other embodiments, each heating element 60 may be configured to operate within a set temperature range that is selected by the user. The temperature range may vary between low, medium and high temperatures, for example.

Still referring now to FIG. 8, the TMJ tool 20 may be configured to include vibration modules 62 in each of the upper and lower tongs 32, 34. Each vibration module 62 is embedded within the upper or lower tongs 32, 34. The vibration generated by the vibration modules 62 also enhances muscle relaxation or stimulation to provide additional relief for discomfort areas.

Each vibration module 62 is an electromechanical device for generating the vibrations. A vibration frequency of each vibration module 62 may typically range from 20 to 60 Hz. This is equivalent to a speed of 1,200-3,600 rotations per minute (rpm). The 20 to 60 Hz range is not to be limiting, as each vibration module 62 may be configured to have a vibration frequency with a range of 1 to 1,000 Hz.

A vibration amplitude may be varied over the range of the vibration frequencies. In one embodiment, each vibration module 62 may be configured to have a vibration amplitude ranging from 1 to 10 mm.

The vibration modules 62 are also battery operated. Each vibration module 62 may have its own battery co-located at the vibration module. In other embodiments, the TMJ tool 20 includes a shared battery to power all three of the vibration modules 62. The individual batteries or the shared battery may be rechargeable by connecting a cable of a charger to a charging port within the TMJ tool 20.

Each vibration module 62 may have its own on/off switch for individual control. In other embodiments, a single on/off switch may be used to operate the vibration modules 62 so that they all vibrate at the same time.

The TMJ tool 20 may be configured to include in each of the upper and lower tongs 30, 32 both the heating element 60 and the vibration modules 62. In other embodiments, the TMJ tool 20 may be configured to include in each of the upper and lower tongs 30, 32 either the heating element 60 or the vibration modules 62.

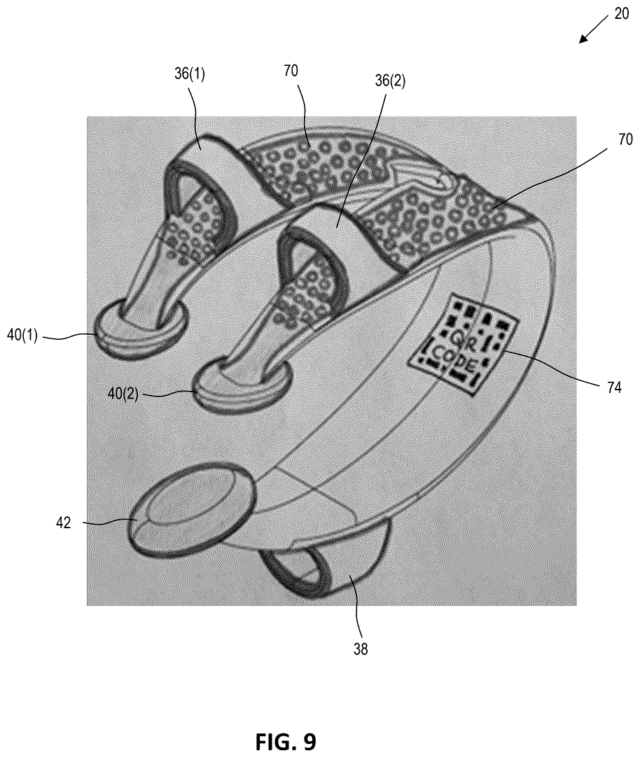

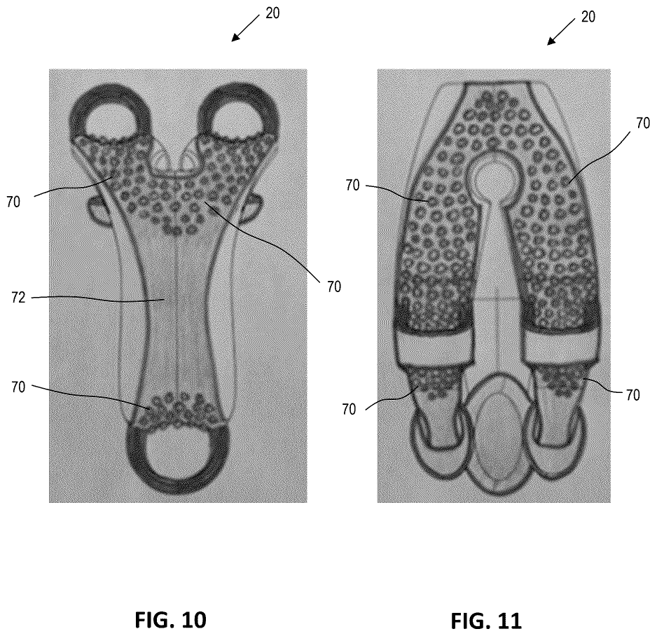

Referring now to FIGS. 9-11, the TMJ tool 20 may be configured to include textured gripping surfaces 70. The textured gripping surfaces 70 advantageously aid the user when gripping the TMJ tool 20 and applying pressure to the user's jaw area.

The textured gripping surfaces 70 may be formed with silicon that is inlaid in the core gripping section 30, and in the upper and lower tongs 30, 32. In other embodiments, the textured gripping surfaces 70 may wrap around the core gripping section 30, and the upper and lower tongs 30, 32. The gripping surfaces 70 may be void of the textured surface on a portion 72 of the core gripping section 30 that is to make contact with the palm of the user's hand.

The upper and lower finger loop holders 36, 38 may also be formed out of silicon, or the silicon wraps around a plastic ring in each finger loop holder. Should anyone of the upper or lower tongs 32, 34 slip from a contact point in the user's mouth while pressure is being applied, then the silicon finger loop 36, 38 may hit the user's teeth. Since the silicon finger loop is soft and flexible, any discomfort to the user is significantly reduced or eliminated.

The TMJ tool 20 may carry a QR code 74. The QR code 74 allows the user to access instructions on how to use the TMJ tool 20. The instructions may be both text and video.

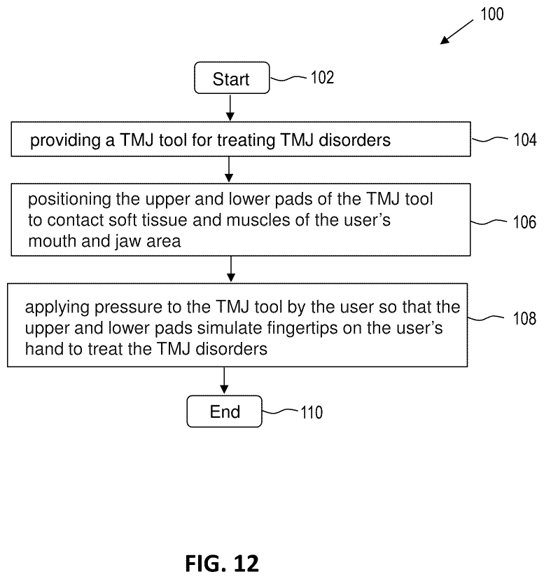

Another aspect is directed to a method for using the TMJ tool 20 as discussed above to treat TMJ disorders. Referring now to the flowchart 100 in FIG. 12, from the start (Block 102), the method includes providing the TMJ tool 20 at Block 104, and positioning the upper and lower pads 40, 42 to contact soft tissue and muscles of the user's mouth and jaw area at Block 106. The muscles to be treated may include at least one of a masseter muscle, a medial pterygoid and a lateral pterygoid. Pressure is applied at Block 208 to the TMJ tool 20 by the user so that the upper and lower pads 40, 42 simulate fingertips on the user's hand to treat the TMJ disorders. The method ends at Block 110.

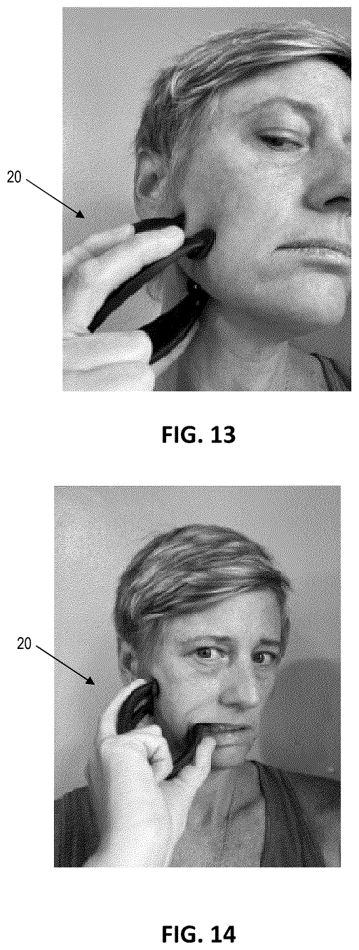

The pressure may be applied to the soft tissue and muscles outside of the user's mouth and jaw area, as illustrated in FIG. 13. Pressure may be applied to different muscles until trigger points are released. Pressure may also be applied as myofascial release therapy. The upper pads 40 are positioned above the jaw area and the lower pad 42 is positioned under a chin area of the user.

The pressure may be applied to the soft tissue and muscles inside of the user's mouth and jaw area, as illustrated in FIG. 14. The user's mouth is opened and the lower pad 42 is inserted until contact is made with the soft tissue and muscles inside the mouth. The upper pads 40 remain outside the user's mouth. Alternatively, one or both of the upper pads 40 may be inserted until contact is made with the soft tissue and muscles inside the mouth while the lower pad 42 remains outside the user's mouth. As in FIG. 13, pressure may be applied to different muscles until trigger points are released, and the pressure may also be applied as myofascial release therapy.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A temporomandibular joint (TMJ) tool for treating TMJ disorders comprising:
a core gripping section configured to be carried in a palm of a user's hand;
a pair of upper tongs extending outwards from an upper end of the core gripping section, with each upper tong having a free end that is movable;
a lower tong extending outwards from a lower end of the core gripping section, with the lower tong having a free end that is movable;
a pair of upper pads carried by the free ends of the pair of upper tongs; and
a lower pad carried by the free end of the lower tong; and
with the upper and lower pads being configured to simulate fingertips on the user's hand when the TMJ tool is treating the TMJ disorders.

2. The TMJ tool according to claim 1 wherein the core gripping section has an arcuate shape, the pair of upper tongs has an arcuate shape, and the lower tong has an arcuate shape.

3. The TMJ tool according to claim 2 wherein, based on the respective arcuate shapes, the pair of upper pads are facing the lower pad.

4. The TMJ tool according to claim 1 wherein the upper and lower tongs each comprise a finger loop holder configured to hold in place fingers on the user's hand when the TMJ tool is treating the TMJ disorders.

5. The TMJ tool according to claim 4 wherein each finger loop holder comprises silicon.

6. The TMJ tool according to claim 1 wherein a medial section of the upper end of the core gripping section includes an opening that separates the pair of upper tongs.

7. The TMJ tool according to claim 5 wherein the opening is circular-shaped to allow at least one of lateral movement and circular movement of the pair of upper tongs.

8. The TMJ tool according to claim 1 wherein the upper and lower pads each comprise silicon.

9. The TMJ tool according to claim 1 wherein the core gripping section, the pair of upper tongs and the lower tong comprise a flexible material so that the TMJ tool is pliable.

10. The TMJ tool according to claim 9 wherein the flexible material comprises a thermoplastic.

11. The TMJ tool according to claim 9 wherein the core gripping section, the pair of upper tongs and the lower tong each comprise a textured gripping surface.

12. The TMJ tool according to claim 1 wherein the upper and lower tongs each comprise a respective vibration module configured to vibrate the respective upper and lower tongs when the TMJ tool is treating the TMJ disorders.

13. The TMJ tool according to claim 1 wherein the free ends of the upper and lower tongs each comprise a respective heating element configured to heat the respective upper and lower pads when the TMJ tool is treating the TMJ disorders.

14. A method for treating temporomandibular joint (TMJ) disorders comprising:
providing a TMJ tool comprising:
a core gripping section configured to be carried in a palm of a user's hand,
a pair of upper tongs extending outwards from an upper end of the core gripping section, with each upper tong having a free end that is movable,
a lower tong extending outwards from a lower end of the core gripping section, with the lower tong having a free end that is movable,
a pair of upper pads carried by the free ends of the pair of upper tongs, and
a lower pad carried by the free end of the lower tong;
positioning the upper and lower pads to contact soft tissue and muscles of the user's mouth and jaw area; and
applying pressure to the TMJ tool by the user so that the upper and lower pads simulate fingertips on the user's hand to treat the TMJ disorders.

15. The method according to claim 14 wherein the pressure is applied to the soft tissue and muscles outside of the user's mouth and jaw area.

16. The method according to claim 15 wherein the upper pads are positioned above the jaw area and the lower pad is positioned under a chin area of the user.

17. The method according to claim 14 wherein the pressure is applied to the soft tissue and muscles inside of the user's mouth and jaw area.

18. The method according to claim 17 wherein at least one of the upper pads is placed inside the user's mouth while the lower pad is placed outside the user's mouth.

19. The method according to claim 17 wherein the lower pad is placed inside the user's mouth while the upper pads are placed outside the user's mouth.

20. The method according to claim 14 wherein the muscles comprise at least one of a masseter muscle, a medial pterygoid and a lateral pterygoid.
